(19) United States
(12) Patent Application Publication
(10) Pub. No.: US 2026/0073821 A1
(43) Pub. Date: Mar. 12, 2026

(54) VEHICLE PROJECTION DEVICE

(71) Applicant: Nippon Seiki Co., Ltd., Niigata (JP)

(72) Inventors: Kozo Morita, Niigata (JP); Saiji Yokoyama, Niigata (JP)

(21) Appl. No.: 19/303,435

(22) Filed: Aug. 19, 2025

(30) Foreign Application Priority Data
Sep. 10, 2024 (JP) 2024-155403

(51) Int. Cl. G09F 21/04; B60Q 1/26; B60Q 1/50

(52) U.S. Cl. CPC G09F 21/048; B60Q 1/2661; B60Q 1/50

(57) ABSTRACT

Please replace the Abstract of the Disclosure with the following paragraph: Provided is a vehicle projection device capable of properly displaying an image even when a door is opened. The vehicle projection device includes an opening and closing detection sensor that senses an opening and closing state of doors of a vehicle, a side mirror projector that performs a desired first projection display on an outer surfaces of the doors, and a control unit, and the control unit executes a variable projection process for changing a display state of the first projection display by the side mirror projector, based on a sensing result of the opening and closing state by the opening and closing detection sensor.

### TECHNICAL FIELD

The present invention relates to a vehicle projection device for providing a desired display to a viewer outside a vehicle.

### BACKGROUND ART

Conventionally, for example, a vehicle display device described in Patent Document 1 is known. In such a display device, a projector is installed in a side mirror of an automobile, and projects an image onto a surface of a side panel of the automobile. The side panel includes a front door panel and a rear door panel.

### PRIOR ART DOCUMENT

### Patent Document

Patent Document 1: JP 6373594 B1

### SUMMARY OF INVENTION

### Technical Problem

However, the above-mentioned conventional display device has a problem in that it is not possible to properly display an image when a door is opened.

The present invention is achieved to solve the above problems, and an object of the present invention is to provide a vehicle projection device capable of properly displaying an image even when a door is opened.

### Solution to Problem

The present invention provides a vehicle projection device 1 provided on a vehicle C including openable and closeable doors 3F and 3R, and the vehicle projection device 1 includes an opening and closing detection sensor 5 that senses an opening and closing state of the doors 3F and 3R, a side mirror projector 11 that performs a desired first projection display on an outer surface of the doors 3F and 3R, and a control unit 7, in which the control unit 7 executes a variable projection process for changing a display state of the first projection display by the side mirror projector 11, based on a sensing result of the opening and closing state by the opening and closing detection sensor 5.

### Advantageous Effects of Invention

According to the present invention, it is possible to provide a vehicle projection device capable of properly displaying an image even when a door is opened.

### BRIEF DESCRIPTION OF DRAWINGS

FIG. 1 is a side view of a vehicle mounted with a vehicle projection device with a door closed according to a first embodiment.

FIG. 2 is a side view of the vehicle mounted with the vehicle projection device with a rear door opened according to the first embodiment.

FIG. 3 is a functional block diagram illustrating a functional configuration of the vehicle projection device according to the first embodiment.

FIG. 4 is a side view of the vehicle in a case where information with a high priority is left in a variable projection process executed by a control unit.

FIG. 5 is a side view of the vehicle illustrating another example of a case in which information with a high priority is left.

FIG. 6 is a side view of the vehicle illustrating yet another example of a case in which information with a high priority is left.

FIG. 7 is a side view of the vehicle illustrating still another example of a case in which information with a high priority is left.

FIG. 8 is a flowchart illustrating control contents when the control unit performs the variable projection process illustrated in FIGS. 4 to 7.

FIG. 9 is a side view of the vehicle in a case where an image is slid in the variable projection process executed by the control unit.

FIG. 10 is a flowchart illustrating control contents when the control unit performs the variable projection process illustrated in FIG. 9.

FIG. 11 is a side view of the vehicle in a case where a doorman is displayed in the variable projection process executed by the control unit.

FIG. 12 is a flowchart illustrating control contents when the control unit performs the variable projection process illustrated in FIG. 11.

FIG. 13 is a side view of the vehicle illustrating another example of a case where a doorman is displayed in the variable projection process executed by the control unit.

FIG. 14 is a flowchart illustrating control contents when the control unit performs the variable projection process illustrated in FIG. 13.

FIG. 15 is a side view of a vehicle in a case where a carpet is displayed in the variable projection process executed by the control unit.

FIG. 16 is a flowchart illustrating control contents when the control unit performs the variable projection process illustrated in FIG. 15.

FIG. 17 is a side view of the vehicle in a case where an advertisement display is deleted in the variable projection process executed by the control unit.

FIG. 18 is a flowchart illustrating control contents when the control unit performs the variable projection process illustrated in FIG. 17.

FIG. 19 is a functional block diagram illustrating a functional configuration of a vehicle projection device according to a second embodiment.

FIG. 20 is a side view of the vehicle in a case where a doorman is displayed depending on an opening and closing state of a door and a position of a scheduled passenger in the variable projection process executed by the control unit.

FIG. 21 is a flowchart illustrating control contents when the control unit performs the variable projection process illustrated in FIG. 20.

FIG. 22 is a side view of the vehicle in a case where a projection direction is changed depending on an opening angle of a swing door in the variable projection process executed by the control unit.

FIG. 23 is a side view of the vehicle in a case where a projection display is slid and moved depending on the opening and closing state of the door in the variable projection process executed by the control unit.

### DESCRIPTION OF EMBODIMENTS

### First Embodiment

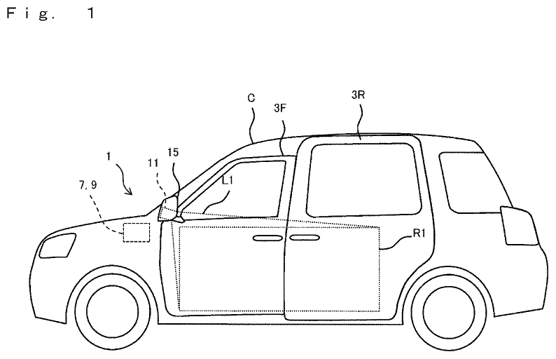

A first embodiment of a vehicle projection device according to the present invention will be described with reference to FIGS. 1 to 18.

### <Configuration of Vehicle and Vehicle Projection Device>

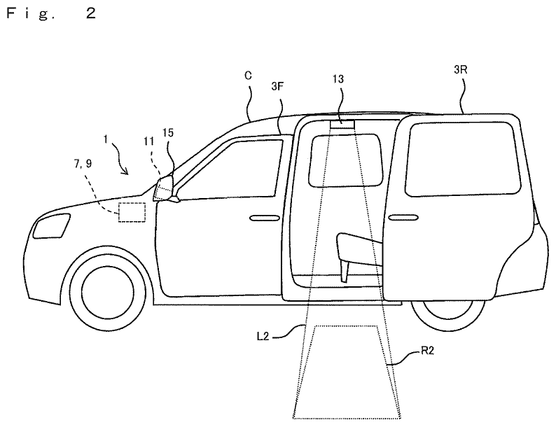

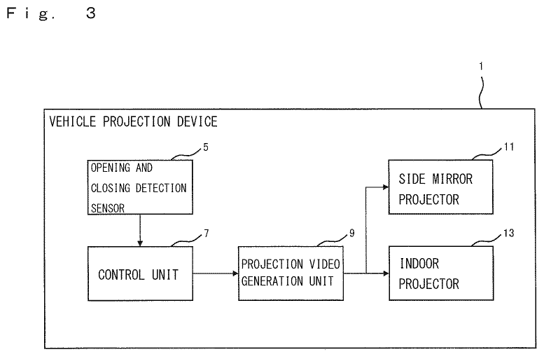

A configuration of a vehicle and the vehicle projection device according to the first embodiment will be described with reference to FIGS. 1 to 3. FIG. 1 is a side view of a vehicle C mounted with a vehicle projection device 1 with a door closed according to the first embodiment. FIG. 2 is a side view of the vehicle C mounted with the vehicle projection device 1 with a rear door opened according to the first embodiment. FIG. 3 is a functional block diagram illustrating a functional configuration of the vehicle projection device 1 according to the first embodiment.

As illustrated in FIGS. 1 and 2, the vehicle projection device 1 is provided in the vehicle C including openable and closeable doors 3F and 3R. As illustrated in FIG. 3, the vehicle projection device 1 includes an opening and closing detection sensor 5 (opening and closing sensing unit) that senses an opening and closing state of the doors 3F and 3R, a control unit 7, a projection video generation unit 9, a side mirror projector 11 (first projection unit), and an indoor projector 13 (second projection unit).

As illustrated in FIGS. 1 and 2, the vehicle C includes the door 3F (second door) on the front side of the left side (one side in a width direction) and the door 3R (first door) on the rear side thereof. Hereinafter, the door 3F will be referred to as a “front door 3F” and the door 3R will be referred to as a “rear door 3R” as appropriate. The front door 3F is a swing door opening and closing by pivoting about a predetermined shaft center. The rear door 3R is a sliding door sliding along the side of the vehicle C to open and close. The rear door 3R may be a swing door. The number of doors on one side of the vehicle C is not limited to two, but may be one, or three or more. The vehicle C also includes doors similar to the doors 3F and 3R on the right side.

The side mirror projector 11 is provided inside or outside a left side mirror 15 of the vehicle C, and performs a first projection display onto the doors 3F and 3R where the first projection display is projected and which are located behind the side mirror projector 11. Specifically, the side mirror projector 11 performs the first projection display by illuminating a first region R1 on the outer surfaces of the doors 3F and 3R of the vehicle C with a first illumination light L1 representing a predetermined image. In the present embodiment, a case is described where the predetermined image is, for example, an advertisement image, but the predetermined image may be an image other than an advertisement. The first region R1 may be a region spanning both the doors 3F and 3R, or may be a region fitting within either of the doors 3F and 3R. The side mirror projector 11 may be provided only on the left side mirror 15 of the vehicle C, or on both the left and right side mirrors of the vehicle C.

As illustrated in FIG. 2, the indoor projector 13 is provided inside the vehicle C, and when the rear door 3R is open, the indoor projector 13 performs a second projection display by emitting a second illumination light L2 representing the predetermined image onto a second region R2 of a road surface serving as a boarding and alighting path for a passenger entering or exiting the vehicle C through the rear door 3R. In the present embodiment, a case is described where the predetermined image is, for example, an image (for example, an image of a carpet) for presenting the boarding and alighting path for a passenger, but other images (for example, an advertisement image) may also be used. The indoor projector 13 is attached at the left side of a roof of the vehicle C, for example. It is noted that the indoor projector 13 may be provided only on the left side of the roof of the vehicle C, or on both the left and right sides of the roof.

As illustrated in FIG. 3, the opening and closing detection sensor 5 senses an opening and closing state of the doors 3F and 3R. The opening and closing state includes not only whether the doors 3F and 3R are opened or closed, but also a position of an open door (a sliding position in a case of a sliding door, a rotation angle in a case of a swing door, or the like). The opening and closing detection sensor 5 may be an imaging sensor such as a camera, a non-contact sensor such as a magnetic, optical or ultrasonic sensor, or a mechanical sensor such as a limit switch or a microswitch.

The control unit 7 executes a variable projection process for changing the display state of the first projection display by the side mirror projector 11, based on a sensing result of the opening and closing state of the doors 3F and 3R by the opening and closing detection sensor 5. The control unit 7 also controls execution of the second projection display by the indoor projector 13 in conjunction with control on the side mirror projector 11 by the variable projection process. The control unit 7 executes the variable projection process triggered as a result of the doors 3F and 3R being opened from a closed state, or triggered as a result of the doors 3F and 3R being closed from an open state. The variable projection process will be described below in detail.

The projection video generation unit 9 generates a video to be projected by the side mirror projector 11 onto the first region R1 and a video to be projected by the indoor projector 13 onto the second region R2, based on control of the control unit 7.

### <Specific Example of Variable Projection Process>

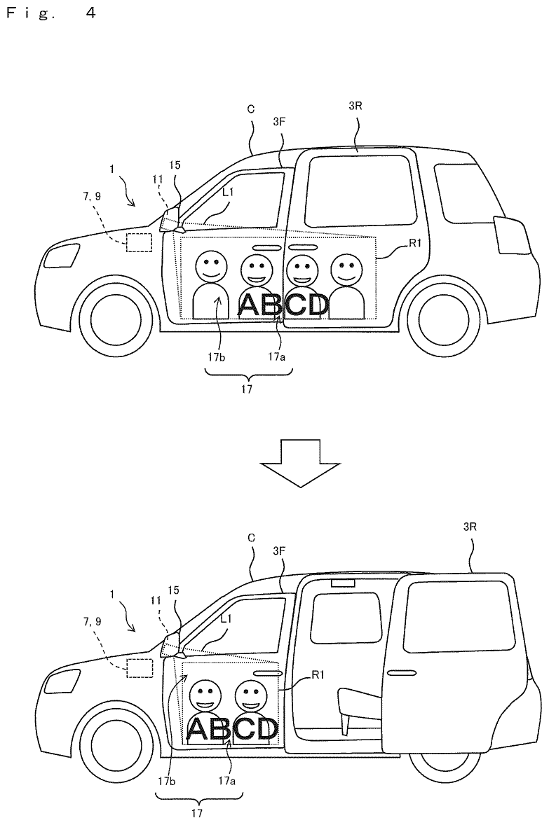

Next, a specific example of the variable projection process executed by the control unit 7 will be described with reference to FIGS. 4 to 18.

<Case where Information with High Priority is Left>

In the variable projection process, if the control unit 7 changes a projection range depending on open positions of the doors 3F and 3R where a first projection display is projected, the control unit 7 changes the display state of the first projection display on the doors 3F and 3R. In such a case, if the display information displayed on the doors 3F and 3R includes a plurality of items of display information with a display priority different from each other, the control unit 7 may delete display information in order from display information with the lowest priority, or cause display information to appear in order from display information with the highest priority, among the plurality of items of display information. In the example illustrated in FIG. 4, a first projection display 17 displayed in the first region R1 spanning the doors 3F and 3R includes a plurality of items of display information with a display priority different from each other. For example, the first projection display 17 includes text information 17a indicating a product name, a service name, or the like, and background information 17b including a plurality of persons. The text information 17a is display information with a higher priority than the background information 17b. In the example illustrated in FIG. 4, when the rear door 3R is opened, the control unit 7 deletes both end portions not including the text information 17a in the background information 17b with a low priority, to leave the text information 17a with a high priority on the front door 3F.

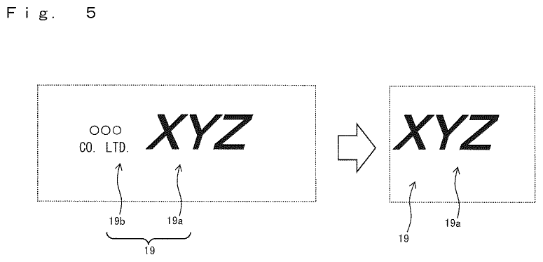

FIG. 5 illustrates another example of the first projection display including a plurality of items of display information with different priorities. In the example illustrated in FIG. 5, a first projection display 19 includes text information 19a indicating a product name, a service name, or the like, and text information 19b indicating a company name. The text information 19a is display information with a higher priority than the text information 19b. In such a case, when the rear door 3R is opened, the control unit 7 deletes the text information 19b with a low priority in the variable projection process. In other words, the control unit 7 causes only the text information 19a with a high priority to appear on the front door 3F.

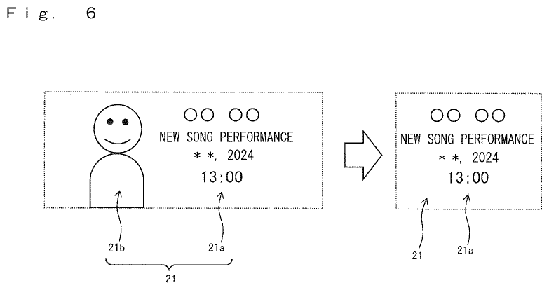

FIG. 6 illustrates yet another example of the first projection display including a plurality of items of display information with different priorities. In the example illustrated in FIG. 6, a first projection display 21 includes text information 21a indicating a date and time of an event (a new song presentation in the example of FIG. 6) and a person image 21b of an organizer of the event. The text information 21a is display information with a higher priority than the person image 21b. In such a case, when the rear door 3R is opened, the control unit 7 deletes the person image 21b with a low priority in the variable projection process. In other words, the control unit 7 causes only the text information 21a with a high priority to appear on the front door 3F.

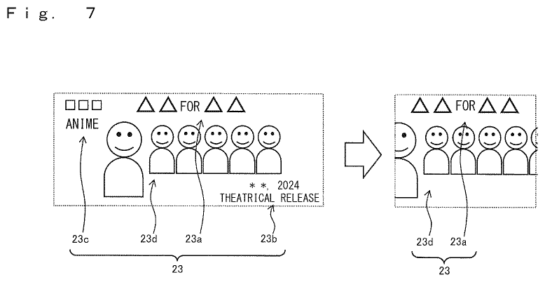

FIG. 7 illustrates still another example of the first projection display including a plurality of items of display information with different priorities. In the example illustrated in FIG. 7, a first projection display 23 includes text information 23a indicating a title of a movie, text information 23b indicating a date and time of a theatrical release of the movie, text information 23c indicating a series name of the movie (a name of an anime in the example of FIG. 7), and background information 23d including movie characters. The text information 23a has the highest priority, the text information 23b has the second highest priority, the text information 23c has the third highest priority, and the background information 23d has the lowest priority. In such a case, when the rear door 3R is opened, the control unit 7 deletes a part of both sides of the background information 23d, the text information 23c, and the text information 23b in order from display information with the lowest priority in the variable projection process. In other words, the control unit 7 causes only the text information 23a with the highest priority and the background information 23d around the text information 23a to appear on the front door 3F.

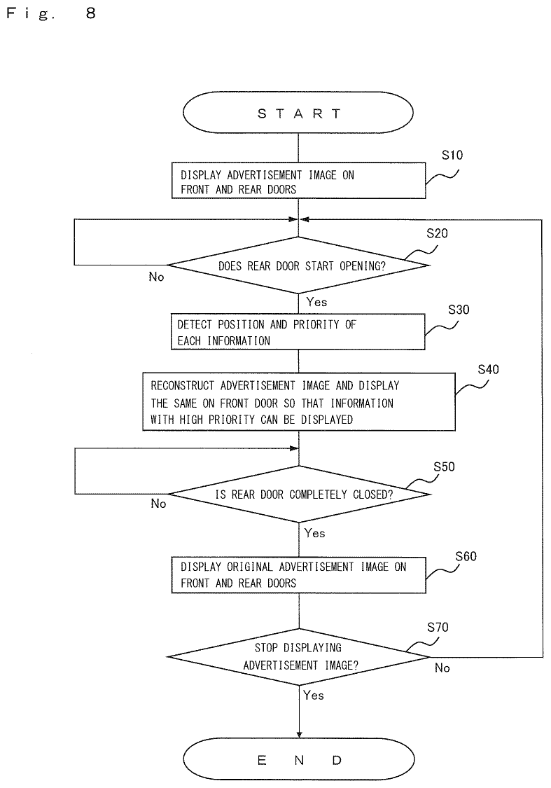

FIG. 8 is a flow chart illustrating control contents when the control unit 7 performs the variable projection process illustrated in FIG. 4 to 7. As illustrated in FIG. 8, the control unit 7 causes the side mirror projector 11 to illuminate the first region R1 on the outer surface of the doors 3F and 3R of the vehicle C to display an advertisement image on the doors 3F and 3R (S10).

Next, the control unit 7 determines whether the rear door 3R starts opening, based on a sensing result by the opening and closing detection sensor 5 (S20). The control unit 7 repeats S20 until the rear door 3R starts opening, and upon determining that the rear door 3R starts opening, the control unit 7 detects the position and the priority of each item of information included in the advertisement image (S30). Next, the control unit 7 reconstructs the advertisement image so that the information with a high priority can be displayed, and displays the resultant image on the front door 3F (S40) (variable projection process).

Next, the control unit 7 determines whether the rear door 3R is completely closed, based on a sensing result by the opening and closing detection sensor 5 (S50). The control unit 7 repeats S50 until the rear door 3R is completely closed, and upon determining that the rear door 3R is completely closed, the control unit 7 returns the image being displayed to the original advertisement image and displays the original advertisement image on the doors 3F and 3R (S60) (variable projection process).

Next, the control unit 7 determines whether a stop command to stop displaying the advertisement image is received (S70). The control unit 7 determines that the stop command is received, for example, when a driver turns off an advertisement display switch or stops an engine. If the control unit 7 does not receive the stop command to stop displaying the advertisement image, the process returns to S20. On the other hand, upon receiving the stop command to stop displaying the advertisement image, the control unit 7 ends the process.

<Case where Image is Slid>

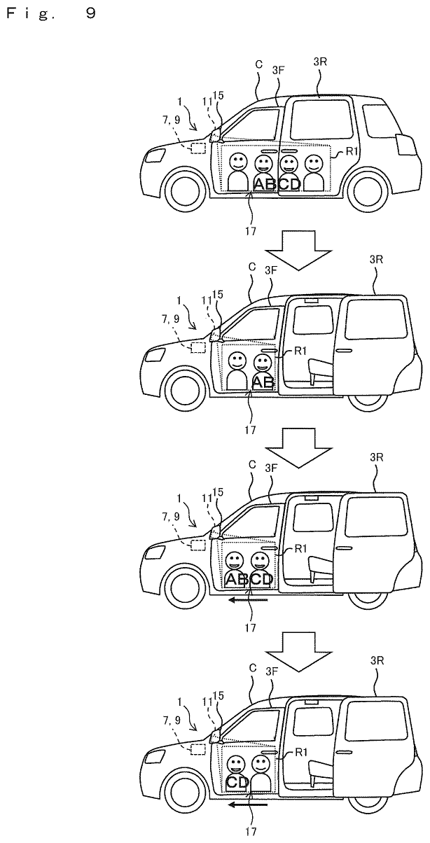

In the variable projection process, the control unit 7 changes a projection range depending on a sliding position of the doors 3F and 3R where a first projection display is projected, to change a display state of the first projection display on the doors 3F and 3R. At that time, in the variable projection process, the control unit 7 may delete the first region R1 of the first projection display on the rear door 3R depending on the opening and closing state of the rear door 3R, and responding to such deleting, slide the display content of the first projection display on the front door 3F within the display area of the front door 3F to display the display content on the rear door 3R. In the example illustrated in FIG. 9, similarly to FIG. 4 described above, the first projection display 17 is displayed in the first region R1 spanning the doors 3F and 3R. When the rear door 3R is opened, the control unit 7 deletes the first region R1 of the first projection display 17 on the rear door 3R to leave only the first region R1 on the front door 3F. As a result, the first region R1 is narrower, and thus, the display content on the rear door 3R is no longer displayed. Therefore, the control unit 7 slides forward the first projection display 17 displayed in the first region R1 on the front door 3F to display the display content on the rear door 3R. That is, the first projection display 17 on the front door 3F is slid and moved forward using animation (a moving image).

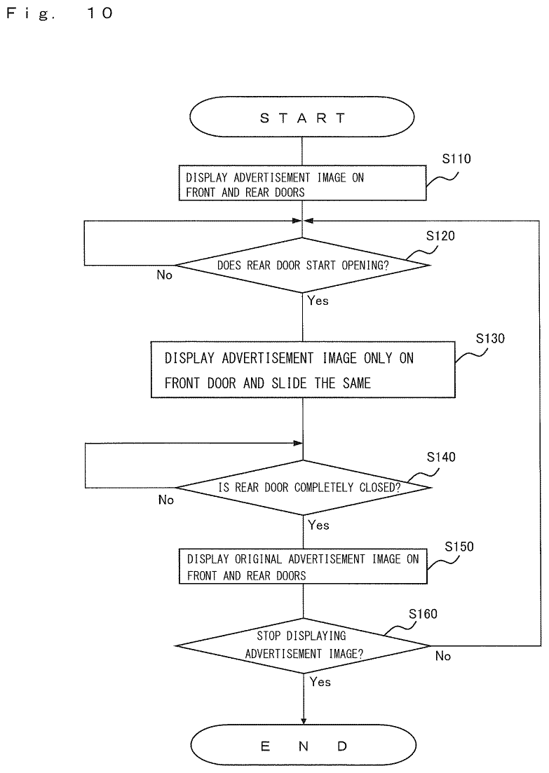

FIG. 10 is a flowchart illustrating control contents when the control unit 7 performs the variable projection process illustrated in FIG. 9. As illustrated in FIG. 10, the control unit 7 causes the side mirror projector 11 to illuminate the first region R1 on the outer surface of the doors 3F and 3R of the vehicle C to display an advertisement image on the doors 3F and 3R (S110).

Next, the control unit 7 determines whether the rear door 3R starts opening, based on a sensing result by the opening and closing detection sensor 5 (S120). The control unit 7 repeats S120 until the rear door 3R starts opening, and upon determining that the rear door 3R starts opening, the control unit 7 displays the advertisement image only on the front door 3F, and slides the advertisement image to display the entire image (S130) (variable projection process). The sliding operation of the image may be performed only once or a preset number of times, or may be performed continuously and repeatedly.

Next, the control unit 7 determines whether the rear door 3R is completely closed, based on a sensing result by the opening and closing detection sensor 5 (S140). The control unit 7 repeats S140 until the rear door 3R is completely closed, and upon determining that the rear door 3R is completely closed, the control unit 7 returns the image being displayed to the original advertisement image and displays the original advertisement image on the doors 3F and 3R (S150) (variable projection process).

Next, the control unit 7 determines whether a stop command to stop displaying the advertisement image is received (S160). If the control unit 7 does not receive the stop command to stop displaying the advertisement image, the process returns to S120. On the other hand, upon receiving the stop command to stop displaying the advertisement image, the control unit 7 ends the process.

<Case where Doorman is Displayed>

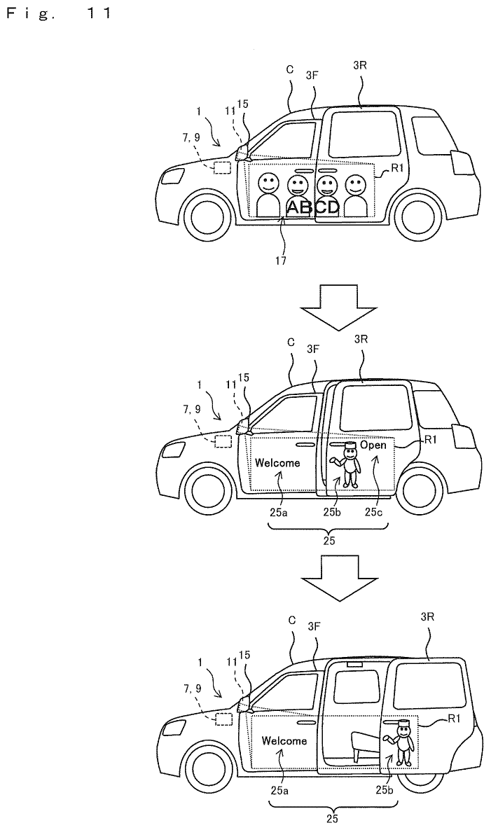

In the variable projection process, the control unit 7 may replace, with another image, the image of the first projection display displayed on the doors 3F and 3R where the image is projected, depending on the opening and closing state of the doors 3F and 3R. In the example illustrated in FIG. 11, similarly to FIG. 4 described above, the first projection display 17 is displayed in the first region R1 spanning the doors 3F and 3R. When the rear door 3R is opened, the control unit 7 switches the first projection display 17 to a first projection display 25 being another image. The first projection display 25 includes, for example, a character image 25a, “Welcome” displayed on the front door 3F, and a doorman image 25b and a character image 25c, “Open” displayed on the rear door 3R. When the rear door 3R moves rearward and the character image 25c, “Open” moves outside a projectable area, the control unit 7 stops displaying the character image 25c and displays only the doorman image 25b.

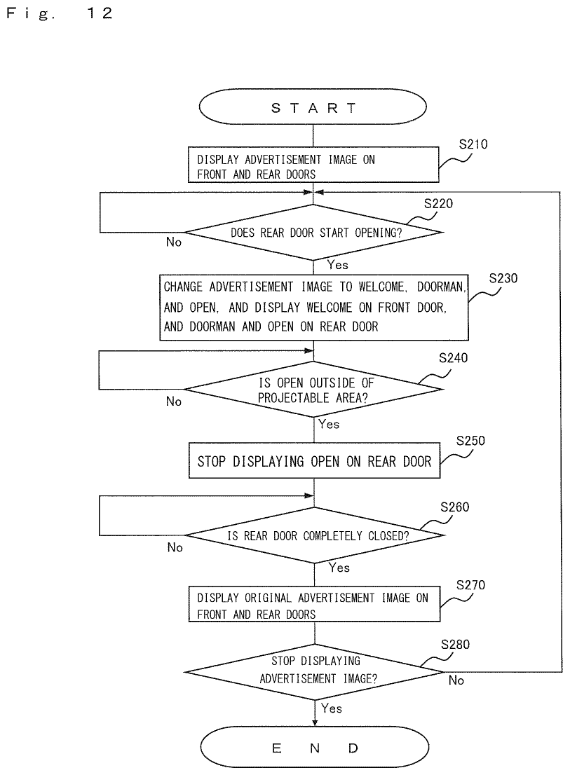

FIG. 12 is a flowchart illustrating control contents when the control unit 7 performs the variable projection process illustrated in FIG. 11. As illustrated in FIG. 12, the control unit 7 causes the side mirror projector 11 to illuminate the first region R1 on the outer surface of the doors 3F and 3R of the vehicle C to display an advertisement image on the doors 3F and 3R (S210).

Next, the control unit 7 determines whether the rear door 3R starts opening, based on a sensing result by the opening and closing detection sensor 5 (S220). The control unit 7 repeats S220 until the rear door 3R starts opening, and upon determining that the rear door 3R starts opening, the control unit 7 changes the advertisement image to an image including the characters “Welcome”, the doorman image, and the characters “Open”, and displays the characters “Welcome” on the front door 3F, and the doorman image and the characters “Open” on the rear door 3R (S230) (variable projection process).

Next, the control unit 7 determines whether the characters “Open” fall outside the projectable area when the rear door 3R moves rearward, based on a sensing result by the opening and closing detection sensor 5 (S240). The control unit 7 repeats S240 until the characters “Open” are outside the projectable area, and when the characters “Open” are outside the projectable area, the control unit 7 stops displaying the characters “Open” on the rear door 3R and displays only the doorman image (S250).

Next, the control unit 7 determines whether the rear door 3R is completely closed, based on a sensing result by the opening and closing detection sensor 5 (S260). The control unit 7 repeats S260 until the rear door 3R is completely closed, and upon determining that the rear door 3R is completely closed, the control unit 7 returns the image being displayed to the original advertisement image and displays the original advertisement image on the doors 3F and 3R (S270) (variable projection process).

Next, the control unit 7 determines whether a stop command to stop displaying the advertisement image is received (S280). If the control unit 7 does not receive the stop command to stop displaying the advertisement image, the process returns to S220. On the other hand, upon receiving the stop command to stop displaying the advertisement image, the control unit 7 ends the process.

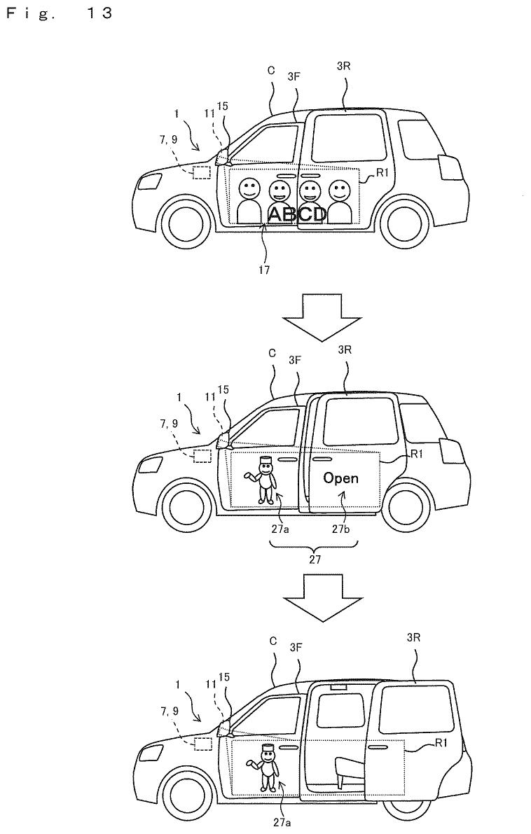

FIG. 13 illustrates another example of a case where the doorman is displayed. In the example illustrated in FIG. 13, when the rear door 3R is opened, the control unit 7 switches the first projection display 17 to a first projection display 27 being another image. The first projection display 27 includes, for example, an image 27a of the doorman displayed on the front door 3F and a character image 27b “Open” displayed on the rear door 3R. When the rear door 3R moves rearward and the character image 27b “Open” moves out of the projectable area, the control unit 7 stops displaying the character image 27b.

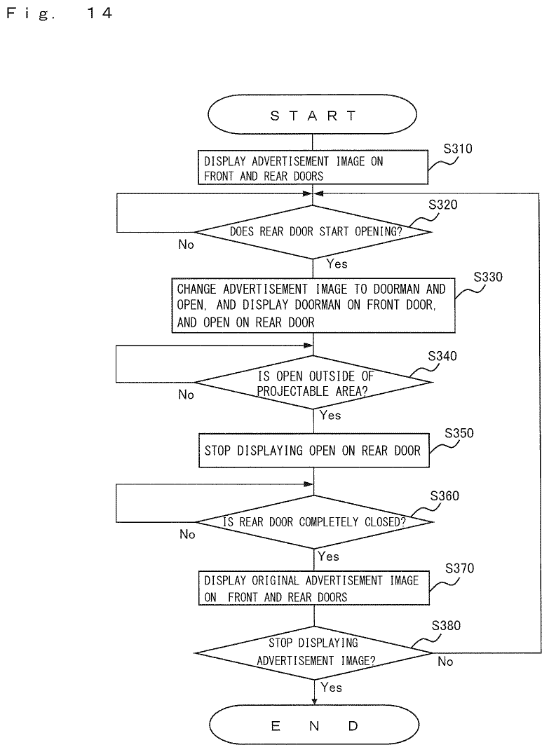

FIG. 14 is a flowchart illustrating control contents when the control unit 7 performs the variable projection process illustrated in FIG. 13. As illustrated in FIG. 14, the control unit 7 causes the side mirror projector 11 to illuminate the first region R1 on the outer surface of the doors 3F and 3R of the vehicle C to display an advertisement image on the doors 3F and 3R (S310).

Next, the control unit 7 determines whether the rear door 3R starts opening, based on a sensing result by the opening and closing detection sensor 5 (S320). The control unit 7 repeats S320 until the rear door 3R starts opening, and upon determining that the rear door 3R starts opening, the control unit 7 changes the advertisement image to an image including the doorman image and the characters “Open” and displays the doorman image on the front door 3F and the characters “Open” on the rear door 3R (S330) (variable projection process).

Next, the control unit 7 determines whether the characters “Open” fall outside the projectable area when the rear door 3R moves rearward, based on a sensing result by the opening and closing detection sensor 5 (S340). The control unit 7 repeats S340 until the characters “Open” are outside the projectable area, and when the characters “Open” are outside the projectable area, the control unit 7 stops displaying the characters “Open” on the rear door 3R and displays only the doorman image (S350).

Next, the control unit 7 determines whether the rear door 3R is completely closed, based on a sensing result by the opening and closing detection sensor 5 (S360). The control unit 7 repeats S360 until the rear door 3R is completely closed, and upon determining that the rear door 3R is completely closed, the control unit 7 returns the image being displayed to the original advertisement image and displays the original advertisement image on the doors 3F and 3R (S370) (variable projection process).

Next, the control unit 7 determines whether a stop command to stop displaying the advertisement image is received (S380). If the control unit 7 does not receive the stop command to stop displaying the advertisement image, the process returns to S320. On the other hand, upon receiving the stop command to stop displaying the advertisement image, the control unit 7 ends the process.

<Case where Carpet is Displayed>

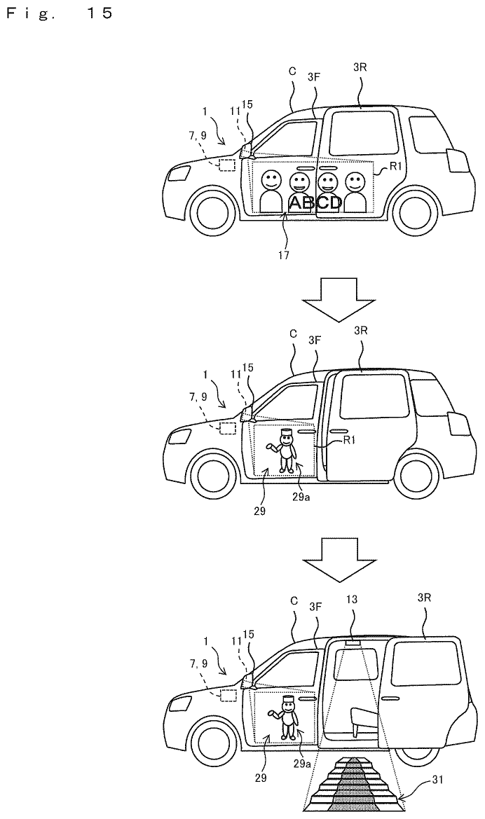

In the variable projection process, the control unit 7 may replace, with another image, the image of the first projection display displayed on the doors 3F and 3R where the image is projected, depending on the opening and closing state of the doors 3F and 3R. The control unit 7 may also control the indoor projector 13 in conjunction with the control on the side mirror projector 11 by the variable projection process, to perform a desired second projection display onto the road surface. In the example illustrated in FIG. 15, similarly to FIG. 4 described above, the first projection display 17 is displayed in the first region R1 spanning the doors 3F and 3R. When the rear door 3R is opened, the control unit 7 switches the first projection display 17 to a first projection display 29 being another image. The first projection display 29 includes, for example, an image 29a of a doorman displayed on the front door 3F. The control unit 7 controls the indoor projector 13 to perform a second projection display 31 onto a road surface serving as a boarding and alighting path for a passenger entering or exiting the vehicle C through the rear door 3R when the rear door 3R is opened. The second projection display 31 is, for example, an image of a carpet laid on stairs.

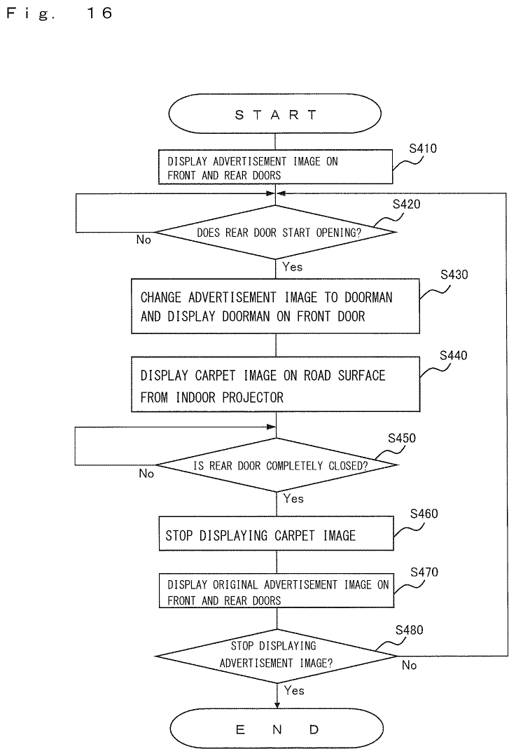

FIG. 16 is a flowchart illustrating control contents when the control unit 7 performs the variable projection process illustrated in FIG. 15. As illustrated in FIG. 16, the control unit 7 causes the side mirror projector 11 to illuminate the first region R1 on the outer surface of the doors 3F and 3R of the vehicle C to display an advertisement image on the doors 3F and 3R (S410).

Next, the control unit 7 determines whether the rear door 3R starts opening, based on a sensing result by the opening and closing detection sensor 5 (S420). The control unit 7 repeats S420 until the rear door 3R starts opening, and upon determining that the rear door 3R starts opening, the control unit 7 changes the advertisement image to a doorman image and displays the doorman image on the front door 3F (S430) (variable projection process). Next, the control unit 7 causes the indoor projector 13 to illuminate the second region R2 of the road surface serving as a boarding and alighting path for the vehicle C to display an image of a carpet (S440).

Next, the control unit 7 determines whether the rear door 3R is completely closed, based on a sensing result by the opening and closing detection sensor 5 (S450). The control unit 7 repeats S450 until the rear door 3R is completely closed, and upon determining that the rear door 3R is completely closed, the control unit 7 stops displaying the image of the carpet by the indoor projector 13 (S460). The control unit 7 also returns the doorman image being displayed on the front door 3F to the original advertisement image, and displays the original advertisement image on the doors 3F and 3R (S470) (variable projection process).

Next, the control unit 7 determines whether a stop command to stop displaying the advertisement image is received (S480). If the control unit 7 does not receive the stop command to stop displaying the advertisement image, the process returns to S420. On the other hand, upon receiving the stop command to stop displaying the advertisement image, the control unit 7 ends the process.

<Case where Advertisement Display is Deleted>

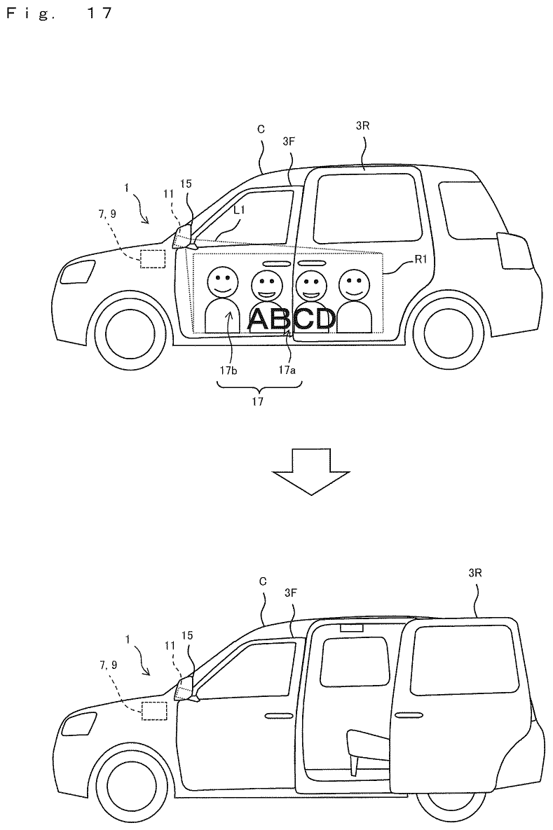

In the variable projection process, the control unit 7 may delete the first projection display displayed on the doors 3F and 3R where the first projection display is projected depending on the opening and closing state of the doors 3F and 3R. In the example illustrated in FIG. 17, similarly to FIG. 4 described above, the first projection display 17 is displayed in the first region R1 spanning the doors 3F and 3R. The control unit 7 stops the first projection display 17 when the rear door 3R is opened. The control unit 7 may also stop the first projection display 17 when the front door 3F is opened.

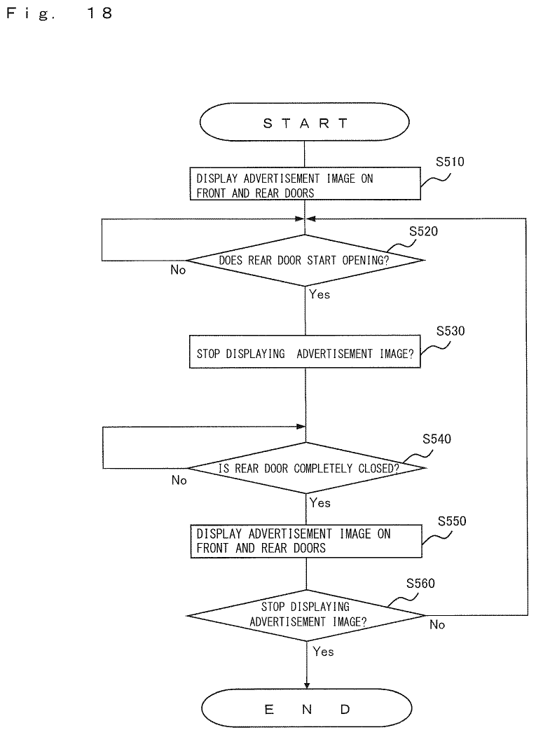

FIG. 18 is a flowchart illustrating control contents when the control unit 7 performs the variable projection process illustrated in FIG. 17. As illustrated in FIG. 18, the control unit 7 causes the side mirror projector 11 to illuminate the first region R1 on the outer surface of the doors 3F and 3R of the vehicle C to display an advertisement image on the doors 3F and 3R (S510).

Next, the control unit 7 determines whether the rear door 3R starts opening, based on a sensing result by the opening and closing detection sensor 5 (S520). The control unit 7 repeats S520 until the rear door 3R starts opening, and upon determining that the rear door 3R starts opening, the control unit 7 stops displaying the advertisement image on the doors 3F and 3R (S530) (variable projection process).

Next, the control unit 7 determines whether the rear door 3R is completely closed, based on a sensing result by the opening and closing detection sensor 5 (S540). The control unit 7 repeats S540 until the rear door 3R is completely closed, and upon determining that the rear door 3R is completely closed, the control unit 7 displays the original advertisement image on the doors 3F and 3R (S550) (variable projection process).

Next, the control unit 7 determines whether a stop command to stop displaying the advertisement image is received (S560). If the control unit 7 does not receive the stop command to stop displaying the advertisement image, the process returns to S520. On the other hand, upon receiving the stop command to stop displaying the advertisement image, the control unit 7 ends the process.

### Effects of First Embodiment

As described above, in the vehicle projection device 1 according to the first embodiment, the control unit 7 senses the opening and closing state of the doors 3F and 3R, and changes the display projected by the side mirror projector 11 depending on the sensing result. As a result, even when the rear door 3R is opened, the projected information can be displayed so that a viewer outside the vehicle C can properly and visually recognize the projected information. It is also possible to avoid a display which the viewer cannot visually recognize properly (such as a display lacking important information).

If necessary, the control unit 7 can change the projection range from the side mirror projector 11 depending on a position where the rear door 3R is slid to be opened, and thus, can display the advertisement information so that the advertisement information can be properly and visually recognized by the viewer.

If necessary, the control unit 7 can turn off the projection display when the doors 3F and 3R are opened, and thus, prevent a meaningless and unnecessary display which the viewer outside the vehicle C cannot visually recognize properly.

If necessary, when the rear door 3R is opened and the projection display on the rear door 3R is deleted, the control unit 7 slides the displayed image within the display area of the front door 3F so that the display content on the rear door 3R is displayed on the front door 3F. This provides a display manner such that the projection display on the front door 3F is moved in a sliding manner by an animation (moving image). As a result, even when the rear door 3R is opened, the advertisement information can be displayed so that the viewer outside the vehicle C can properly and visually recognize the advertisement information.

If necessary, when the display information displayed on the doors 3F and 3R includes a plurality of items of display information with a display priority different from each other, the control unit 7 deletes the display information in order from display information with the lowest priority, or causes display information to appear in order from display information with the highest priority, among the plurality of items of display information. This makes it possible to leave important information until the very end so that the viewer can visually recognize the information, and thus, the value of the advertisement is prevented from decreasing.

If necessary, if the control unit 7 is not an obsession for the image of the projection display displayed until that time point, and replaces the image with another image, it is possible to provide a more convenient projection display. For example, a driver of a taxi or the like opens a door to pick up a passenger, and thus, the passenger may be surprised when the door suddenly opens. Therefore, if the image is replaced with an image for notifying the passenger of a fact that the door will open (for example, characters “Welcome”, a doorman image, or characters “Open”), the passenger is prevented from being surprised, and a service can be improved.

If necessary, when the rear door 3R is opened, the control unit 7 can provide a variety of presentations and display services to the passenger entering or exiting the vehicle by the interior projector 13 performing a second projection display 31 from inside the vehicle through the opened rear door 3R onto the road surface serving as a boarding and alighting path in front of the door.

If necessary, if the control unit 7 can execute a variable projection process triggered by the rear door 3R being opened or closed, the control unit 7 can display the projected information so that the viewer outside the vehicle C can properly and visually recognize the projected information, regardless of whether the rear door 3R is opened or closed.

If necessary, if the control unit 7 can perform a projection from the side mirror projector 11 provided on the side mirror 15 toward the doors 3F and 3R behind the side mirror projector 11, the control unit 7 can smoothly project and display a projection display onto the doors 3F and 3R without impairing the appearance of the vehicle C and without blocking the illumination light.

### Second Embodiment

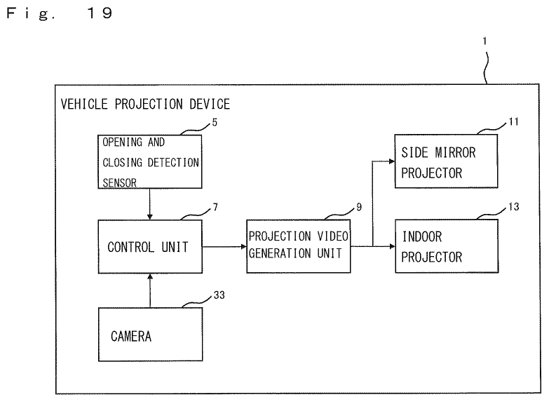

A second embodiment of the vehicle projection device according to the present invention will be described with reference to FIGS. 19 to 21.

### <Functional Configuration of Vehicle Projection Device>

A functional configuration of the vehicle projection device according to the second embodiment will be described with reference to FIG. 19. FIG. 19 is a functional block diagram illustrating the functional configuration of the vehicle projection device 1 according to the second embodiment. In FIG. 19, the configurations similar to those in FIG. 3 described above are denoted by the same reference numerals, and the description thereof will be omitted.

As illustrated in FIG. 19, the vehicle projection device 1 according to the second embodiment includes a camera 33 (position sensing unit) in addition to the opening and closing detection sensor 5, the control unit 7, the projection video generation unit 9, the side mirror projector 11, and the indoor projector 13 as described above. The camera 33 senses a position of a scheduled passenger to board the vehicle C and the scheduled passenger is outside the vehicle C. The camera 33 is, for example, an in-vehicle camera being provided inside the vehicle C and being capable of capturing images in a 360-degree range. In the second embodiment, the control unit 7 executes the variable projection process, based on both the sensing result of the opening and closing state of the doors 3F and 3R by the opening and closing detection sensor 5 and the sensing result of the position of the scheduled passenger by the camera 33.

### <Specific Example of Variable Projection Process>

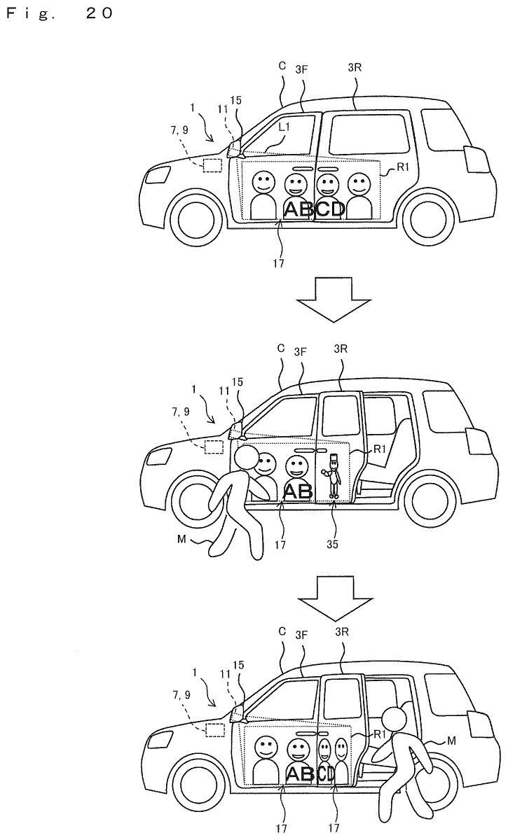

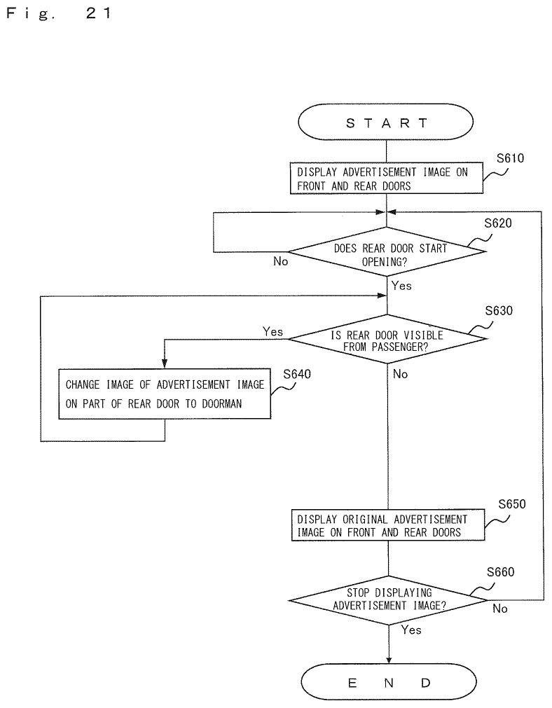

Next, a specific example of the variable projection process executed by the control unit 7 will be described with reference to FIGS. 20 and 21.

As illustrated in FIG. 20, in the second embodiment, the rear door 3R of the vehicle C is a swing door opening and closing by pivoting about a predetermined shaft center. In the example illustrated in FIG. 20, similarly to FIG. 4 described above, the first projection display 17 is displayed in the first region R1 spanning the doors 3F and 3R. When the rear door 3R is rotated to open, if the position of the scheduled passenger M detected by the camera 33 is a position where the outer surface of the rear door 3R is visible, the control unit 7 switches a portion of the first projection display 17 in a region on the rear door 3R to a first projection display 35 being another image. The first projection display 35 is, for example, a doorman image. Then, when the position of the scheduled passenger M detected by the camera 33 is a position where the outer surface of the rear door 3R is not visible, the control unit 7 switches the first projection display 35 on the rear door 3R to the original first projection display 17, and displays the original advertisement image on the doors 3F and 3R. It is noted that a position where the outer surface of the rear door 3R is visible is, for example, a position forward of the rear door 3R or its extension when viewed from above in the vertical direction, and a position where the outer surface of the rear door 3R is not visible is, for example, a position backward of the rear door 3R or its extension when viewed from above in the vertical direction.

FIG. 21 is a flowchart illustrating control contents when the control unit 7 performs the variable projection process illustrated in FIG. 20. As illustrated in FIG. 21, the control unit 7 causes the side mirror projector 11 to illuminate the first region R1 on the outer surface of the doors 3F and 3R of the vehicle C to display an advertisement image on the doors 3F and 3R (S610).

Next, the control unit 7 determines whether the rear door 3R starts opening, based on a sensing result by the opening and closing detection sensor 5 (S620). The control unit 7 repeats S620 until the rear door 3R starts opening, and upon determining that the rear door 3R starts opening, the control unit 7 determines whether the position of the scheduled passenger M detected by the camera 33 is a position where the outer surface of the rear door 3R is visible (S630). If the control unit 7 determines that the position of the scheduled passenger M is a position where the outer surface of the rear door 3R is visible, the control unit 7 changes the image on a portion of the rear door 3R, of the advertisement image to the doorman image (S640) (variable projection process). Then, the process returns to S630.

On the other hand, if the control unit 7 determines in S630 that the position of the scheduled passenger M is a position where the outer surface of the rear door 3R is not visible, the control unit 7 returns the doorman image being displayed on the rear door 3R to the original advertisement image, and displays the original advertisement image on the doors 3F and 3R (S650) (variable projection process).

Next, the control unit 7 determines whether a stop command to stop displaying the advertisement image is received (S660). If the control unit 7 does not receive the stop command to stop displaying the advertisement image, the process returns to S620. On the other hand, upon receiving the stop command to stop displaying the advertisement image, the control unit 7 ends the process.

### Effects of Second Embodiment

As described above, in the vehicle projection device 1 according to the second embodiment, the control unit 7 performs the variable projection process, based on not only the opening and closing state of the rear door 3R but also the position of the scheduled passenger M to board the vehicle C. This makes it possible to provide a more attentive display service.

### <Modification>

The present invention is not limited to the first and second embodiments described above, and various modifications are possible without departing from the spirit and the technical concept of the present invention. Such modifications will be described below step by step. The parts similar to those in the first and second embodiments are given the same reference numerals, and the description will be omitted or simplified as appropriate.

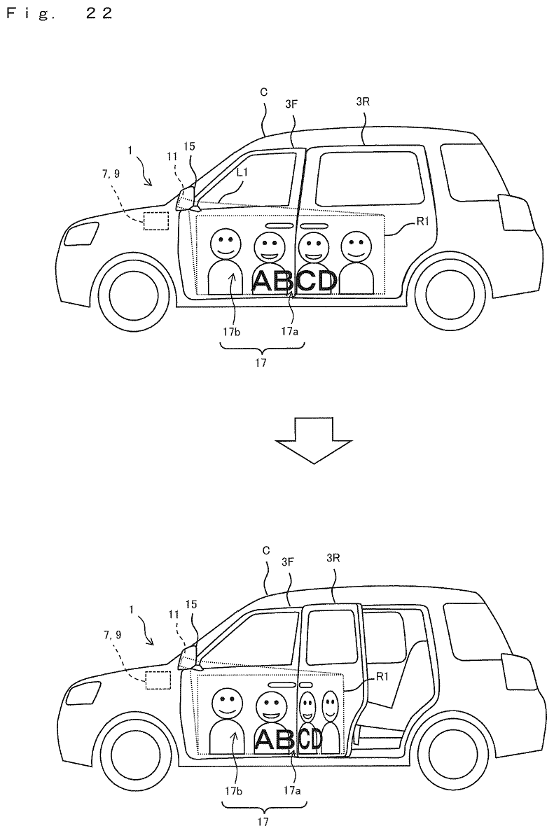

In a modification illustrated in FIG. 22, the rear door 3R of the vehicle C is a swing door opening and closing by pivoting about a predetermined shaft center. In the example illustrated in FIG. 22, similarly to FIG. 4 described above, the first projection display 17 is displayed in the first region R1 spanning the doors 3F and 3R. In the present modification, when the rear door 3R is rotated to open, the control unit 7 changes the display state of the first projection display 17 on the rear door 3R by changing the projection direction of the portion of the first projection display 17 on the rear door 3R depending on the opening angle of the rear door 3R where the first projection display 17 is projected, in the variable projection process. Thus, even if the door to be opened is a swing door, the projected information can be displayed so that a viewer outside the vehicle C can properly and visually recognize the information. It is noted that when the front door 3F pivots to open, the display state of the first projection display 17 on the front door 3F may be changed also by changing the projection direction depending on the opening angle of the front door 3F where the first projection display 17 is projected.

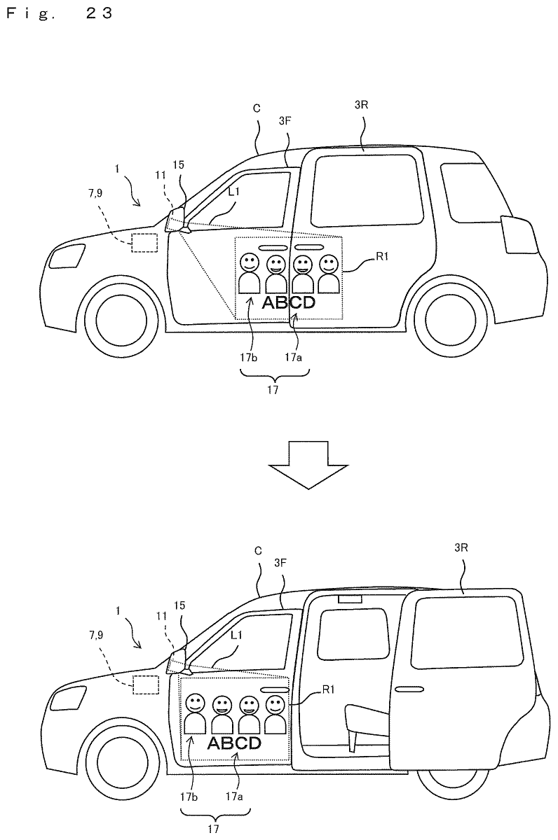

In the modification illustrated in FIG. 23, the rear door 3R of the vehicle C is a sliding door sliding along the side of the vehicle C to open and close. In the example illustrated in FIG. 23, similarly to FIG. 4 described above, the first projection display 17 is displayed in the first region R1 spanning the doors 3F and 3R. In the present modification, the size of the first region R1 in the front-rear direction is smaller than that in FIG. 4 described above. In the present modification, when the rear door 3R is slid to open, the control unit 7 reduces or deletes the display area of the first projection display 17 on the rear door 3R depending on the opening and closing state of the rear door 3R, and causes the first projection display 17 to newly appear on the front door 3F or enlarges the display area of the already displayed first projection display 17 responding to such reducing or deleting, in the variable projection process. As a result, as illustrated in FIG. 23, the first projection display 17 spanning the doors 3F and 3R can be slid and moved onto the front door 3F. Thus, even when the rear door 3R is opened, the projected information can be displayed so that a viewer outside the vehicle C can properly and visually recognize the information. In the example illustrated in FIG. 23, the first projection display 17 is slid without changing its size, but the first projection display 17 may be slid while its size is enlarged or reduced to fit the display region on the front door 3F.

Although the above description is given for a case where the rear door 3R is opened, the similar variable projection process may also be executed when the front door 3F is opened. Although the side mirror projector 11 is described above, the projector (first projection unit) may be placed at a site protruding from the vehicle C other than the side mirror. The side mirror projector 11 illuminates the first region R1 on the outer surface of the doors 3F and 3R of the vehicle C with the first illumination light L1 representing a predetermined image to perform the first projection display, but the side mirror projector 11 may also be a display (first image display unit) such as a thin-film transistor (TFT) that performs the first image display representing a predetermined image in the first region R1.

In addition to the above, the methods according to the above embodiments and modifications may be used in appropriate combination.

Although not specifically illustrated, the present invention can be implemented with various modifications without departing from the spirit of the present invention.

### REFERENCE SIGNS LIST

1 . . . Vehicle projection device
3F . . . Front door
3R . . . Rear door
5 . . . Opening and closing detection sensor (opening and closing sensing unit)
7 . . . Control unit
9 . . . Projection video generation unit
11 . . . Side mirror projector (first projection unit)
13 . . . Indoor projector (second projection unit)
15 . . . Side mirror
17 . . . First projection display
17a . . . Text information
17b . . . Background information
19 . . . First projection display
19a . . . Text information
19b . . . Text information
21 . . . First projection display
21a . . . Text information
21b . . . Person image
23 . . . First projection display
23a . . . Text information
23b . . . Text information
23c . . . Text information
23d . . . Background information
25 . . . First projection display
25a . . . Character image
25b . . . Doorman image
25c . . . Character image
27 . . . First projection display
27a . . . Doorman image
27b . . . Character image
29 . . . First projection display
29a . . . Doorman image
31 . . . Second projection display
33 . . . Camera
35 . . . First projection display
C . . . Vehicle
L1 First illumination light
L2 Second illumination light
M . . . Scheduled passenger
R1 . . . First region
R2 . . . Second region

1. A vehicle projection device provided in a vehicle including a door being openable and closeable, the vehicle projection device comprising:
an opening and closing sensing unit that senses an opening and closing state of the door;
a first projection unit that performs a first projection display as desired on an outer surface of the door; and
a control unit, wherein
the control unit
executes a variable projection process that changes a display state of the first projection display by the first projection unit, based on a sensing result of the opening and closing state by the opening and closing sensing unit.

2. The vehicle projection device according to claim 1, wherein
the door opens and closes by sliding along a side of the vehicle, and
the control unit, in the variable projection process,
changes a display state of the first projection display on the door by changing a projection range depending on a sliding position of the door where the first projection display is projected.

3. The vehicle projection device according to claim 1, wherein
the door opens and closes by pivoting about a predetermined shaft center, and
the control unit, in the variable projection process,
changes a display state of the first projection display on the door by changing a projection direction depending on an opening angle of the door where the first projection display is projected.

4. The vehicle projection device according to claim 1, wherein
the control unit, in the variable projection process,
deletes the first projection display displayed on the door depending on the opening and closing state of the door where the first projection display is projected.

5. The vehicle projection device according to claim 1, wherein
the vehicle includes
a plurality of the doors including a first door and a second door on one side in a width direction, and
the control unit, in the variable projection process,
reduces or deletes a display area of the first projection display on the first door depending on the opening and closing state of the first door, and causes the first projection display to newly appear on the second door or enlarges the display area of the first projection display already displayed, responding to the reducing or deleting.

6. The vehicle projection device according to claim 1, wherein
the vehicle includes
a plurality of the doors including a first door and a second door on one side in a width direction, and
the control unit, in the variable projection process,
deletes the display area of the first projection display on the first door depending on the opening and closing state of the first door, and slides a display content of the first projection display on the second door within the display area of the second door to display the display content on the first door, responding to the deleting.

7. The vehicle projection device according to claim 1, wherein
the first projection display includes
a plurality of items of display information with a display priority different from each other, and
the control unit, in the variable projection process,
deletes the display information in order from display information with a lowest priority, or causes the display information to appear in order from display information with a highest priority, depending on the opening and closing state of the door where the display information is projected, of the display information displayed on the door.

8. The vehicle projection device according to claim 1, wherein
the control unit, in the variable projection process,
replaces an image of the first projection display displayed on the door with another image, depending on the opening and closing state of the door where the display information is projected.

9. The vehicle projection device according to claim 1, further comprising:
a second projection unit that is provided in an interior of the vehicle and performs a second projection display as desired on a road surface serving as a boarding and alighting path for a passenger entering or exiting the vehicle through the door when the door is in an open state, wherein
the control unit controls execution of the second projection display by the second projection unit in conjunction with control on the first projection unit by the variable projection process.

10. The vehicle projection device according to claim 1, wherein the control unit
executes the variable projection process triggered as a result of the door being opened from a closed state or triggered as a result of the door being closed from an open state.

11. The vehicle projection device according to claim 1, further comprising:
a position sensing unit that is located outside the vehicle and senses a position of a scheduled passenger to board the vehicle, wherein
the control unit
executes the variable projection process, based on both the sensing result of the opening and closing state by the opening and closing sensing unit and a sensing result of the position of the scheduled passenger by the position sensing unit.

12. The vehicle projection device according to claim 1, wherein the first projection unit is provided on a side mirror of the vehicle, and performs the first projection display on the door where the first projection display is projected, the door being located behind the first projection unit.
